(19) United States
(12) Patent Application Publication
(10) Pub. No.: US 2026/0353233 A1
(43) Pub. Date: Nov. 5, 2026

(54) METHOD AND APPARATUS FOR AUTONOMOUS SERVING CELL SWITCHING IN A WIRELESS COMMUNICATION SYSTEM

(71) Applicant: LG ELECTRONICS INC., Seoul (KR)

(72) Inventors: Sangwon KIM, Seoul (KR); Sunghoon JUNG, Seoul (KR); Hongsuk KIM, Seoul (KR); Siyoung CHOI, Seoul (KR)

(73) Assignee: LG ELECTRONICS INC., Seoul (KR)

(21) Appl. No.: 19/121,359

(22) PCT Filed: Nov. 23, 2023
(86) PCT No.: PCT/KR2023/019018

§ 371 Date: Apr. 15, 2025

Related U.S. Application Data
(60) Provisional application No. 63/428,735, filed on Nov. 30, 2022.

(51) Int. Cl. H04W 36/30; H04W 36/00; H04W 36/36

(52) U.S. Cl. CPC H04W 36/305; H04W 36/00692; H04W 36/00725; H04W 36/008357; H04W 36/362

(57) ABSTRACT

A method and apparatus for autonomous serving cell switching in a wireless communication system is provided. The wireless device may perform operations comprising: configuring a connection with a serving cell; receiving a configuration for one or more candidate serving cells; acquiring an uplink transmission timing for at least one candidate serving cell among the one or more candidate serving cells; detecting a failure related to the serving cell; selecting a specific candidate serving cell among the at least one candidate serving cell for which the uplink transmission timing is acquired; and performing a serving cell switching from the serving cell to the specific candidate serving cell based on the configuration for the specific candidate serving cell.

### CROSS-REFERENCE TO RELATED APPLICATIONS

This application is the National Stage filing under 35 U.S.C. 371 of International Application No. PCT/KR2023/019018, filed on Nov. 23, 2023, which claims the benefit of U.S. Provisional Application No. 63/428,735 filed on Nov. 30, 2022, the contents of which are all hereby incorporated by reference herein in their entireties.

### TECHNICAL FIELD

The present disclosure relates to a method and apparatus for autonomous serving cell switching in a wireless communication system.

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

### SUMMARY

When the beam failure is detected on a PCell, UE performs Random Access procedure for beam failure recovery. While performing the RA procedure, the uplink transmission and downlink reception are suspended. When the Radio Link Failure is detected, the UE performs the RRC re-establishment procedure and it also requires the UE to perform RA procedure.

If UE has a full configuration of a cell (that is, a candidate serving cell that is already prepared for potential connection) and knows the exact uplink transmission timing, the candidate serving cell can be used by the UE for communication, when the communication with the serving cell is not available due to various reasons.

For example, when the serving cell is not available due to the beam failure or RLF or other failure reasons, the UE can keep performing the uplink transmission and downlink reception using the candidate serving cell even without performing RA procedure, if the UE performs autonomous cell switching from the serving cell to one of the candidate cells whose UL timing is already known.

Therefore, studies for autonomous serving cell switching in a wireless communication system are required.

In an aspect, a method performed by a wireless device in a wireless communication system is provided. The method comprises: configuring a connection with a serving cell; receiving a configuration for one or more candidate serving cells; acquiring an uplink transmission timing for at least one candidate serving cell among the one or more candidate serving cells; detecting a failure related to the serving cell; selecting a specific candidate serving cell among the at least one candidate serving cell for which the uplink transmission timing is acquired; and performing a serving cell switching from the serving cell to the specific candidate serving cell based on the configuration for the specific candidate serving cell.

In another aspect, an apparatus for implementing the above method is provided.

The present disclosure can have various advantageous effects.

According to some embodiments of the present disclosure, a wireless device could efficiently perform the autonomous serving cell switching.

When the serving cell is not available due to the beam failure or RLF, the UE can keep performing the uplink transmission and downlink reception using the candidate serving cell even without performing RA procedure.

In other words, by acquiring the uplink transmission timing in advance, the wireless device could perform the autonomous serving cell switching efficiently.

According to some embodiments of the present disclosure, a wireless communication system could provide an efficient solution for the autonomous serving cell switching.

For example, the network could efficiently provide the configuration and/or the uplink transmission timing of the candidate serving cells for the autonomous serving cell switching.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIGS. 10a and 10b shows an example of Intra-AMF/UPF Conditional Handover

FIG. 11 shows an example of a method for autonomous serving cell switching in a wireless communication system, according to some embodiments of the present disclosure.

FIG. 12 shows an example of a procedure for autonomous serving cell switching.

FIG. 13 shows an example of a method for autonomous serving cell switching performed by a UE.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

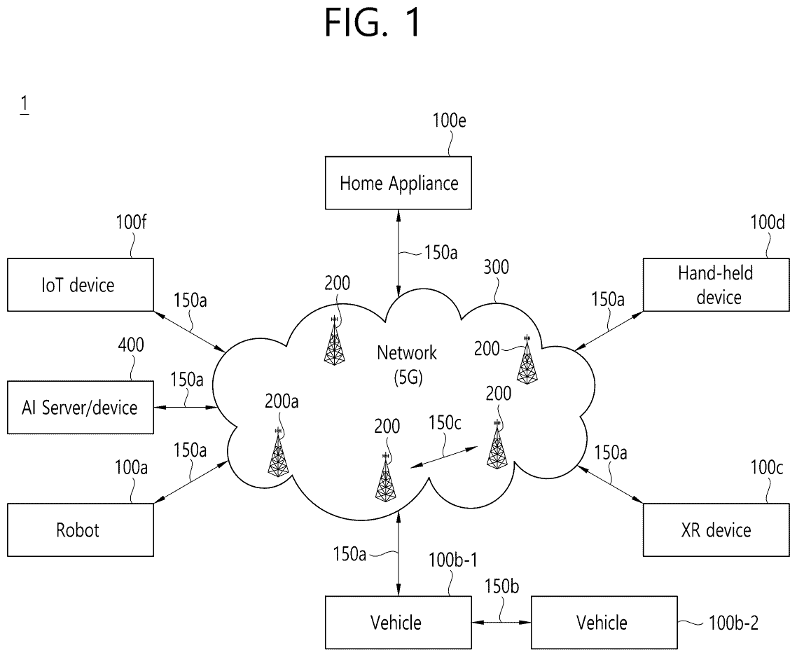

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

Here, the radio communication technologies implemented in the wireless devices in the present disclosure may include narrowband internet-of-things (NB-IoT) technology for low-power communication as well as LTE, NR and 6G. For example, NB-IoT technology may be an example of low power wide area network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced machine type communication (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate personal area networks (PANs) associated with small/low-power digital communication based on various specifications such as IEEE 802.15.4 and may be called various names.

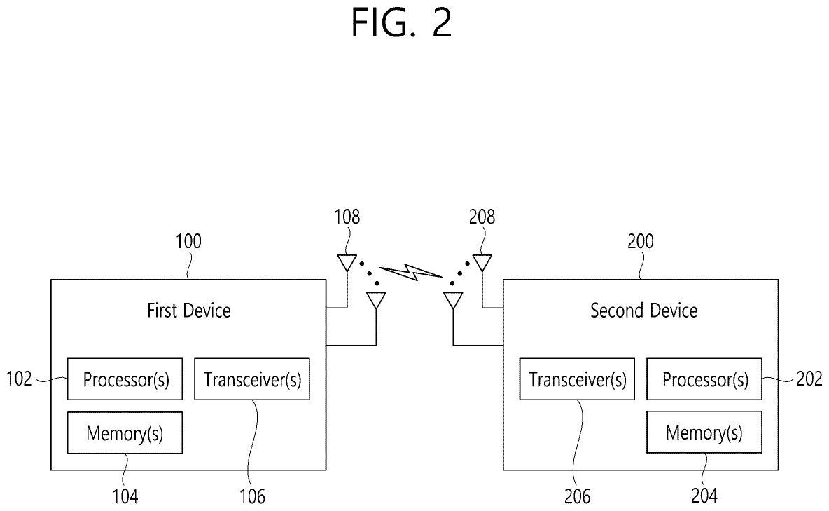

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. Descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

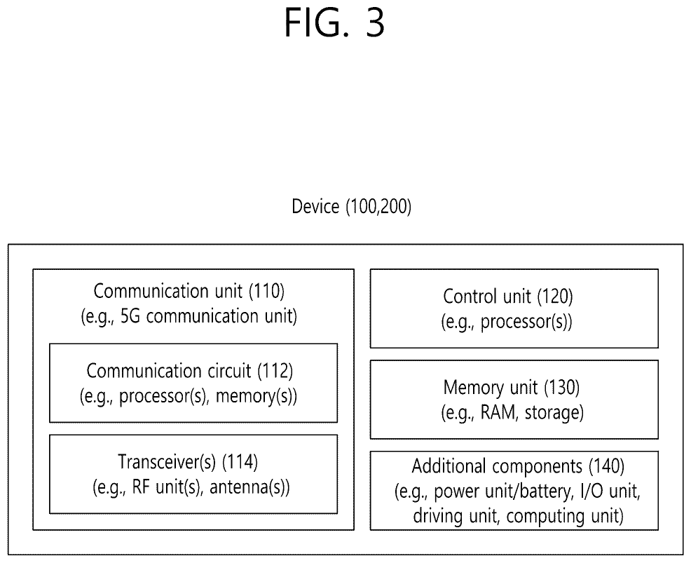

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

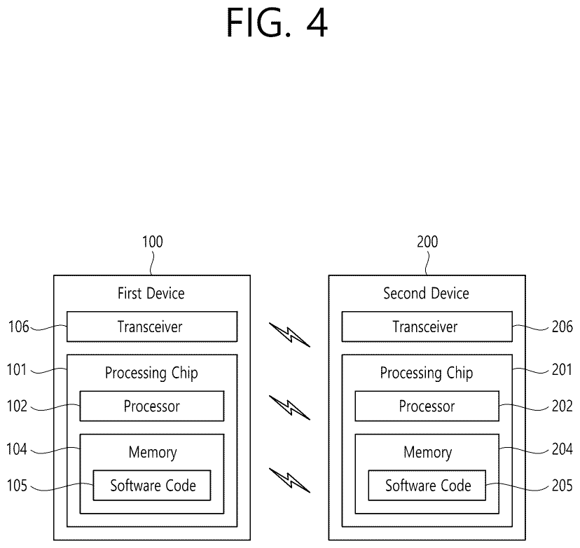

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

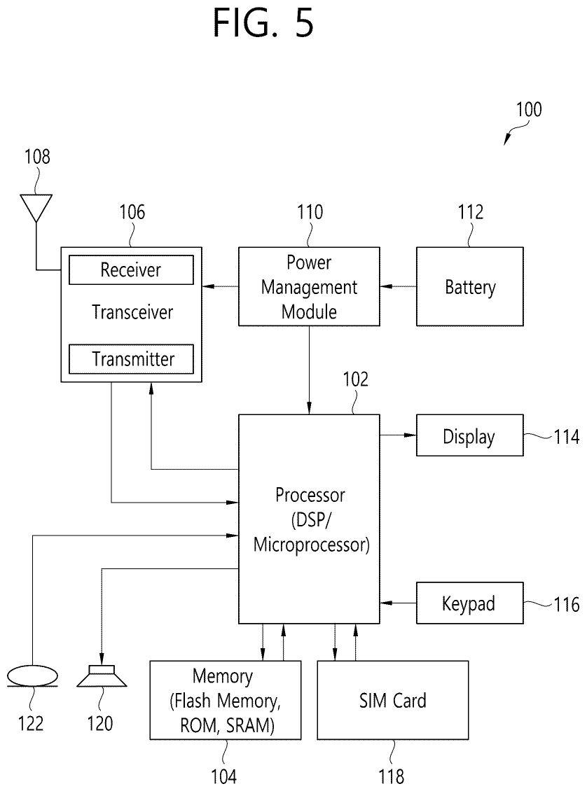

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

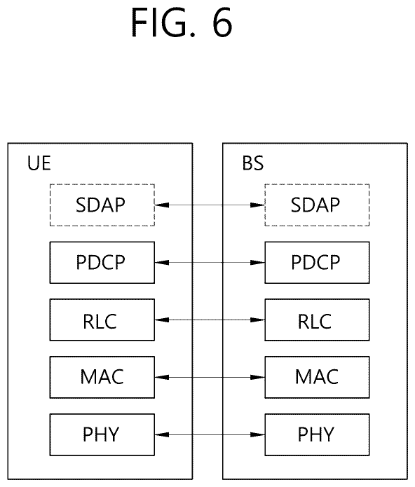

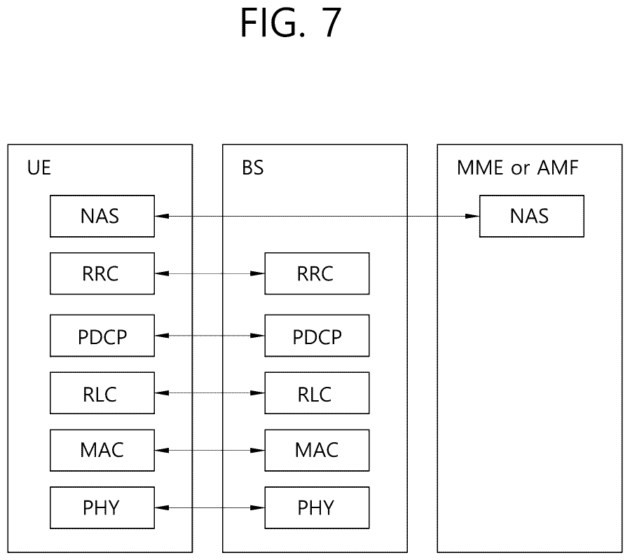

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

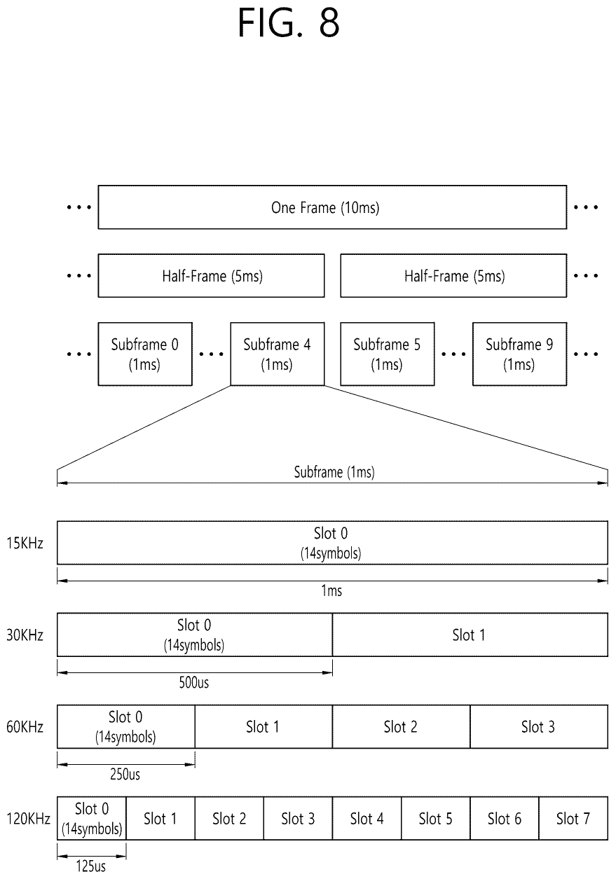

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding frequency | | |
|---|---|---|---|
| designation | range | Subcarrier Spacing | |
| FR1 | 450 MHz-6000 MHz | 15, 30, 60 | kHz |
| FR2 | 24250 MHz-52600 MHz | 60, 120, 240 | kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding frequency | | |
|---|---|---|---|
| designation | range | Subcarrier Spacing | |
| FR1 | 410 MHz-7125 MHz | 15, 30, 60 | kHz |
| FR2 | 24250 MHz-52600 MHz | 60, 120, 240 | kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

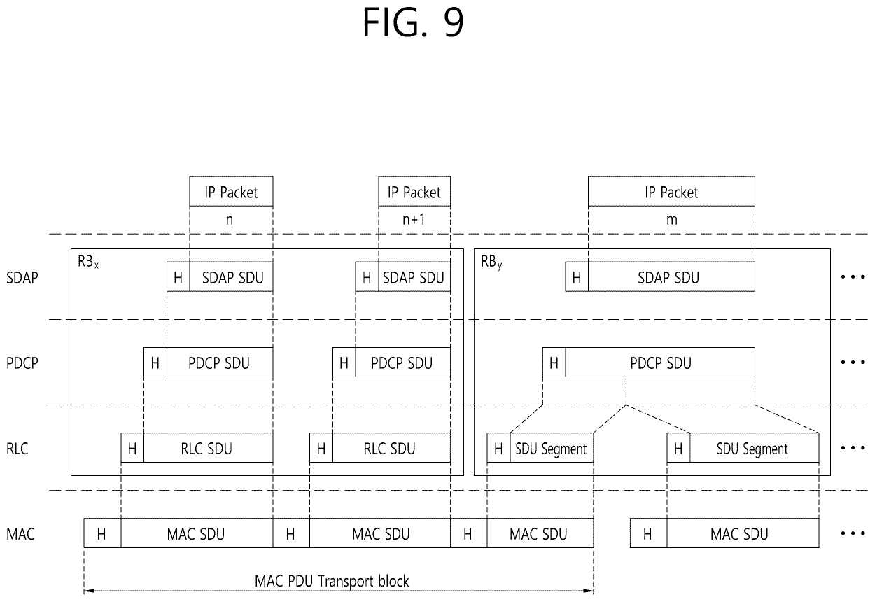

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels PUSCH and PRACH, respectively, and the downlink transport channels DL-SCH, BCH and PCH are mapped to PDSCH, PBCH and PDSCH, respectively. In the PHY layer, uplink control information (UCI) is mapped to PUCCH, and downlink control information (DCI) is mapped to PDCCH. A MAC PDU related to UL-SCH is transmitted by a UE via a PUSCH based on an UL grant, and a MAC PDU related to DL-SCH is transmitted by a BS via a PDSCH based on a DL assignment.

Hereinafter, technical features related to Conditional Reconfiguration (for example, Conditional Handover (CHO), Conditional PSCell Addition (CPA), Conditional PSCell Change (CPC)) are described. Section 5.3.5.13 of 3GPP TS 38.331 v17.2.0 may be referred.

The network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

The UE performs the following actions based on a received ConditionalReconfiguration IE:
1> if the ConditionalReconfiguration contains the condReconfigToRemoveList:
2> perform conditional reconfiguration removal procedure;
1> if the ConditionalReconfiguration contains the condReconfigToAddModList:
2> perform conditional reconfiguration addition/modification;

### Conditional Reconfiguration Addition/Modification

For each condReconfigId received in the condReconfigToAddModList IE the UE shall:
1> if an entry with the matching condReconfigId exists in the condReconfigToAddModList within the VarConditionalReconfig:
2> if the entry in condReconfigToAddModList includes an condExecutionCond or condExecutionCondSCG;
3> replace condExecutionCond or condExecutionCondSCG within the VarConditionalReconfig with the value received for this condReconfigId;
2> if the entry in condReconfigToAddModList includes an condRRCReconfig;
3> replace condRRCReconfig within the VarConditionalReconfig with the value received for this condReconfigId;

1> else:

2> add a new entry for this condReconfigId within the VarConditionalReconfig;

1> perform conditional reconfiguration evaluation;

### Conditional Reconfiguration Evaluation

The UE shall:
1> for each condReconfigId within the VarConditionalReconfig:
2> if the RRCReconfiguration within condRRCReconfig includes the masterCellGroup including the reconfigurationWithSync, consider the cell which has a physical cell identity matching the value indicated in the ServingCellConfigCommon included in the reconfigurationWithSync within the masterCellGroup in the received condRRCReconfig to be applicable cell;
2> if the RRCReconfiguration within condRRCReconfig includes the secondaryCellGroup including the reconfigurationWithSync, consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedures, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig via SRB1:
4> in the remainder of the procedures, consider each measId indicated in the condExecutionCond as a measId in the VarMeasConfig associated with the SCG measConfig;
3> otherwise:
4> in the remainder of the procedures, consider each measId indicated in the condExecutionCond as a measId in the VarMeasConfig associated with the MCG measConfig;
2> for each measId included in the measIdList within VarMeasConfig indicated in the condExecutionCond or condExecutionCondSCG associated to condReconfigId:
3> if the condEventId is associated with condEventT1, and if the entry condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the entry condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution;

Up to 2 MeasId can be configured for each condReconfigId. The conditional reconfiguration event of the 2 MeasId may have the same or different event conditions, triggering quantity, time to trigger, and triggering threshold.

### Conditional Reconfiguration Execution

The UE shall:
1> if more than one triggered cell exists:
2> select one of the triggered cells as the selected cell for conditional reconfiguration execution;
1> else:
2> consider the triggered cell as the selected cell for conditional reconfiguration execution;
1> for the selected cell of conditional reconfiguration execution:
2> apply the stored condRRCReconfig of the selected cell and perform the actions;

If multiple NR cells are triggered in conditional reconfiguration execution, it is up to UE implementation which one to select, e.g. the UE considers beams and beam quality to select one of the triggered cells for execution.

### ReportConfigNR

The IE ReportConfigNR specifies criteria for triggering of an NR measurement reporting event or of a CHO, CPA or CPC event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;
Event D1: Distance between UE and a reference location referenceLocation1 becomes larger than configured threshold1 Thresh and distance between UE and a reference location referenceLocation2 becomes shorter than configured threshold Thresh2;
CondEvent A3: Conditional reconfiguration candidate becomes amount of offset better than PCell/PSCell;
CondEvent A4: Conditional reconfiguration candidate becomes better than absolute threshold;
CondEvent A5: PCell/PSCell becomes worse than absolute threshold1 AND Conditional reconfiguration candidate becomes better than another absolute threshold2;
CondEvent D1: Distance between UE and a reference location referenceLocation1 becomes larger than configured threshold Thresh1 and distance between UE and a reference location referenceLocation2 of conditional reconfiguration candidate becomes shorter than configured threshold Thresh2;
CondEvent T1: Time measured at UE becomes more than configured threshold Thresh1 but is less than Thresh2;
Event X1: Serving L2 U2N Relay UE becomes worse than absolute threshold1 AND NR Cell becomes better than another absolute threshold2;
Event X2: Serving L2 U2N Relay UE becomes worse than absolute threshold;

For event I1, measurement reporting event is based on CLI measurement results, which can either be derived based on SRS-RSRP or CLI-RSSI.
Event IL: Interference becomes higher than absolute threshold.

Hereinafter, technical features related to Radio link failure related actions are described. Section 5.3.5.10 of 3GPP TS 38.331 v17.2.0 may be referred.

### Detection of Physical Layer Problems in RRC_CONNECTED

The UE shall:
1> if any DAPS bearer is configured, upon receiving N310 consecutive “out-of-sync” indications for the source SpCell from lower layers and T304 is running:
2> start timer T310 for the source SpCell.
1> upon receiving N310 consecutive “out-of-sync” indications for the SpCell from lower layers while neither T300, T301, T304, T311, T316 nor T319 are running:
2> start timer T310 for the corresponding SpCell.

### Recovery of Physical Layer Problems

Upon receiving N311 consecutive “in-sync” indications for the SpCell from lower layers while T310 is running, the UE shall:
1> stop timer T310 for the corresponding SpCell.
1> stop timer T312 for the corresponding SpCell, if running.

In this case, the UE maintains the RRC connection without explicit signalling, i.e. the UE maintains the entire radio resource configuration.

Periods in time where neither “in-sync” nor “out-of-sync” is reported by L1 do not affect the evaluation of the number of consecutive “in-sync” or “out-of-sync” indications.

### Detection of Radio Link Failure

The UE shall:
1> if any DAPS bearer is configured and T304 is running:
2> upon T310 expiry in source SpCell; or
2> upon random access problem indication from source MCG MAC; or
2> upon indication from source MCG RLC that the maximum number of retransmissions has been reached; or
2> upon consistent uplink LBT failure indication from source MCG MAC:
3> consider radio link failure to be detected for the source MCG i.e. source RLF;
3> suspend the transmission and reception of all DRBs and multicast MRBs in the source MCG;
3> reset MAC for the source MCG;
3> release the source connection.
1> else:
2> during a DAPS handover: the following only applies for the target PCell;
2> upon T310 expiry in PCell; or
2> upon T312 expiry in PCell; or
2> upon random access problem indication from MCG MAC while neither T300, T301, T304, T311 nor T319 are running; or
2> upon indication from MCG RLC that the maximum number of retransmissions has been reached; or
2> if connected as an IAB-node, upon BH RLF indication received on BAP entity from the MCG; or
2> upon consistent uplink LBT failure indication from MCG MAC while T304 is not running:
3> if the indication is from MCG RLC and CA duplication is configured and activated for MCG, and for the corresponding logical channel allowedServingCells only includes SCell(s):
4> initiate the failure information procedure to report RLC failure.
3> else:
4> consider radio link failure to be detected for the MCG, i.e. MCG RLF;
4> discard any segments of segmented RRC messages stored;
4> if AS security has not been activated:
5> perform the actions upon going to RRC_IDLE, with release cause ‘other’;
4> else if AS security has been activated but SRB2 and at least one DRB or multicast MRB or, for IAB, SRB2, have not been setup:
5> store the radio link failure information in the VarRLF-Report;
5> perform the actions upon going to RRC_IDLE, with release cause ‘RRC connection failure’;
4> else:
5> store the radio link failure information in the VarRLF-Report;
5> if T316 is configured; and
5> if SCG transmission is not suspended; and
5> if the SCG is not deactivated; and
5> if neither PSCell change nor PSCell addition is ongoing (i.e. timer T304 for the NR PSCell is not running in case of NR-DC or timer T307 of the E-UTRA PSCell is not running, in NE-DC):
6> initiate the MCG failure information procedure to report MCG radio link failure.
5> else:
6> initiate the connection re-establishment procedure.

A L2/L3 U2N Relay UE shall:
1> upon detecting radio link failure:
2> it either indicates to upper layers (to trigger PC5 unicast link release) or sends Notification message to the connected L2/L3 U2N Remote UE(s).

The UE shall:
1> upon T310 expiry in PSCell; or
1> upon T312 expiry in PSCell; or
1> upon random access problem indication from SCG MAC; or
1> upon indication from SCG RLC that the maximum number of retransmissions has been reached; or
1> if connected as an IAB-node, upon BH RLF indication received on BAP entity from the SCG; or
1> upon consistent uplink LBT failure indication from SCG MAC:
2> if the indication is from SCG RLC and CA duplication is configured and activated for SCG, and for the corresponding logical channel allowedServingCells only includes SCell(s):
3> initiate the failure information procedure to report RLC failure.
2> else:
3> consider radio link failure to be detected for the SCG, i.e. SCG RLF;
3> if MCG transmission is not suspended:
4> initiate the SCG failure information procedure to report SCG radio link failure.
3> else:
4> if the UE is in NR-DC:
5> initiate the connection re-establishment procedure;
4> else (the UE is in (NG) EN-DC):
5> initiate the connection re-establishment procedure;
Hereinafter, technical features related to Beam Failure Detection and Recovery procedure are described. Section 5.17 of 3GPP TS 38.321 v17.0.0 may be referred.

The MAC entity may be configured by RRC per Serving Cell with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration.

RRC configures the following parameters in the BeamFailureRecoveryConfig, BeamFailureRecoverySCellConfig, BeamFailureRecoveryServingCellConfig and the RadioLinkMonitoringConfig for the Beam Failure Detection and Recovery procedure:
beamFailureInstanceMaxCount for the beam failure detection (per Serving Cell or per BFD-RS set of Serving Cell configured with two BFD-RS sets);
beamFailureDetectionTimer for the beam failure detection (per Serving Cell or per BFD-RS set of Serving Cell configured with two BFD-RS sets);
beamFailureRecoveryTimer for the beam failure recovery procedure;
rsrp-ThresholdSSB: an RSRP threshold for the SpCell beam failure recovery;
rsrp-ThresholdBFR: an RSRP threshold for the SCell beam failure recovery or for the beam failure recovery of BFD-RS set of Serving Cell;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBI: scalingFactorBI for the SpCell beam failure recovery;
ssb-perRACH-Occasion: ssb-perRACH-Occasion for the SpCell beam failure recovery using contention-free Random Access Resources;
ra-ResponseWindow: the time window to monitor response(s) for the SpCell beam failure recovery using contention-free Random Access Resources;
prach-ConfigurationIndex: prach-ConfigurationIndex for the SpCell beam failure recovery using contention-free Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access Resources;
candidateBeamRSList: list of candidate beams for SpCell beam failure recovery;
candidateBeamRSSCellList: list of candidate beams for SCell beam failure recovery;
candidateBeamresourceList: list of candidate beams for beam failure recovery of BFD-RS set 0 of Serving Cell;
candidateBeamresourceList2: list of candidate beams for beam failure recovery of BFD-RS set 1 of Serving Cell.

The following UE variables are used for the beam failure detection procedure:
BFI_COUNTER (per Serving Cell or per BFD-RS set of Serving Cell configured with two BFD-RS sets): counter for beam failure instance indication which is initially set to 0.

All BFRs triggered for an SCell shall be cancelled when a MAC PDU is transmitted and this PDU includes a BFR MAC CE or Truncated BFR MAC CE which contains beam failure information of that SCell. All BFRs triggered for a BFD-RS set of a Serving Cell shall be cancelled when a MAC PDU is transmitted and this PDU includes an Enhanced BFR MAC CE or Truncated Enhanced BFR MAC CE which contains beam failure recovery information of that BFD-RS set of the Serving Cell.

Hereinafter, technical features related to Conditional Handover are described. Section 9.2.3.4 of 3GPP TS 38.300 v17.0.0 may be referred.

A Conditional Handover (CHO) is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO:
The CHO configuration contains the configuration of CHO candidate cell(s) generated by the candidate gNB(s) and execution condition(s) generated by the source gNB.
An execution condition may consist of one or two trigger condition(s) (CHO events A3/A5). Only single RS type is supported and at most two different trigger quantities (e.g. RSRP and RSRQ, RSRP and SINR, etc.) can be configured simultaneously for the evaluation of CHO execution condition of a single candidate cell.
Before any CHO execution condition is satisfied, upon reception of HO command (without CHO configuration), the UE executes the HO procedure, regardless of any previously received CHO configuration.
While executing CHO, i.e. from the time when the UE starts synchronization with target cell, UE does not monitor source cell.

CHO is also supported for the IAB-MT in context of intra- and inter-donor IAB-node migration and BH RLF recovery.

CHO is not supported for NG-C based handover in this release of the specification.

### C-Plane Handling

As in intra-NR RAN handover, in intra-NR RAN CHO, the preparation and execution phase of the conditional handover procedure is performed without involvement of the 5GC; i.e. preparation messages are directly exchanged between gNBs. The release of the resources at the source gNB during the conditional handover completion phase is triggered by the target gNB.

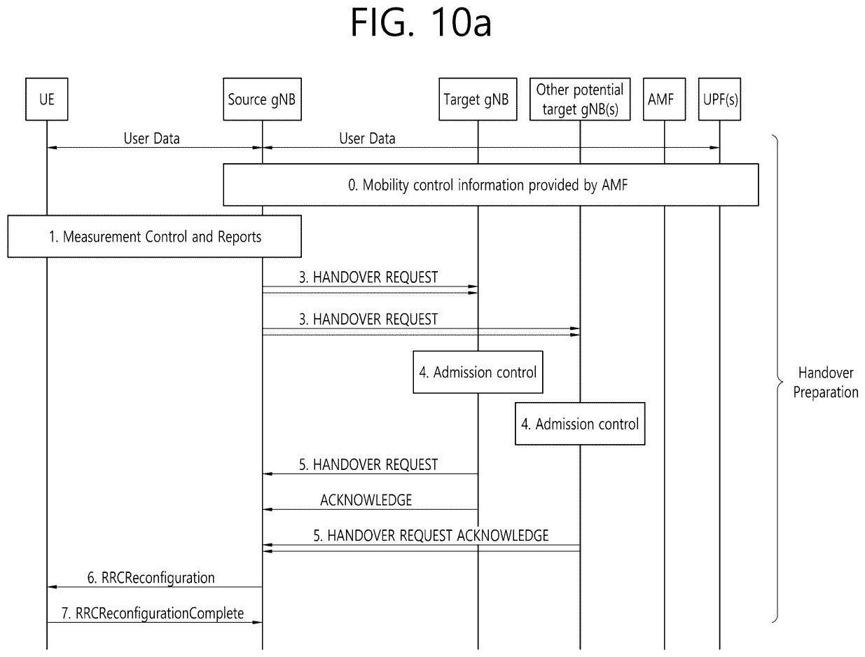

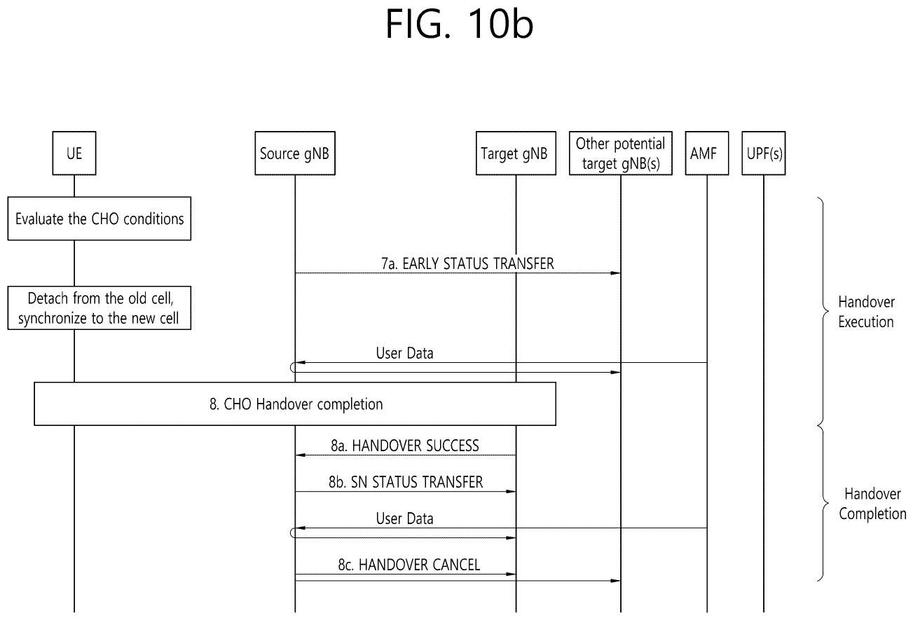

FIGS. 10a and 10b shows an example of Intra-AMF/UPF Conditional Handover

In particular, FIGS. 10a and 10b below depicts the basic conditional handover scenario where neither the AMF nor the UPF changes.
0. The UE context within the source gNB contains information regarding roaming and access restrictions which were provided either at connection establishment or at the last TA update.
1. The source gNB configures the UE measurement procedures and the UE reports according to the measurement configuration.
2. The source gNB decides to use CHO.
3. The source gNB requests CHO for one or more candidate cells belonging to one or more candidate gNBs. A CHO request message is sent for each candidate cell.
4. Admission Control may be performed by the target gNB. Slice-aware admission control shall be performed if the slice information is sent to the target gNB. If the PDU sessions are associated with non-supported slices the target gNB shall reject such PDU Sessions.
5. The candidate gNB(s) sends CHO response (HO REQUEST ACKNOWLEDGE) including configuration of CHO candidate cell(s) to the source gNB. The CHO response message is sent for each candidate cell.
6. The source gNB sends an RRCReconfiguration message to the UE, containing the configuration of CHO candidate cell(s) and CHO execution condition(s).
   CHO configuration of candidate cells can be followed by other reconfiguration from the source gNB.
   A configuration of a CHO candidate cell cannot contain a DAPS handover configuration.
7. The UE sends an RRCReconfigurationComplete message to the source gNB.
7a. If early data forwarding is applied, the source gNB sends the EARLY STATUS TRANSFER message.
8. The UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronises to that candidate cell and completes the RRC handover procedure by sending RRCReconfigurationComplete message to the target gNB. The UE releases stored CHO configurations after successful completion of RRC handover procedure.
8a/b. The target gNB sends the HANDOVER SUCCESS message to the source gNB to inform that the UE has successfully accessed the target cell. In return, the source gNB sends the SN STATUS TRANSFER message following the principles described in step 7 of Intra-AMF/UPF Handover.

Late data forwarding may be initiated as soon as the source gNB receives the HANDOVER SUCCESS message.
8c. The source gNB sends the HANDOVER CANCEL message toward the other signalling connections or other candidate target gNBs, if any, to cancel CHO for the UE.

### U-Plane Handling

The U-plane handling for Conditional Handover follows the same principles for DAPS handover, if early data forwarding is applied, except that, in case of Full Configuration, HFN and PDCP SN are reset in the target gNB after the SN assignment is handed over to the target gNB. If late data forwarding is applied, the U-plane handling follows the RLC-AM or RLC-UM bearer principles.

### Data Forwarding

If late data forwarding is applied, the source NG-RAN node initiates data forwarding once it knows which target NG-RAN node the UE has successfully accessed. In that case the behavior of the Conditional Handover data forwarding follows the same behavior for the intra-system handover data forwarding, except the behavior for DRBs configured with DAPS handover.

If early data forwarding is applied instead, the source NG-RAN node initiates data forwarding before the UE executes the handover, to a candidate target node of interest. The behavior of early data forwarding for the Conditional Handover follows the same principles for DRBs configured with DAPS handover in the intra-system handover.

Meanwhile, when the beam failure is detected on a PCell, UE performs Random Access procedure for beam failure recovery. While performing the RA procedure, the uplink transmission and downlink reception are suspended. When the Radio Link Failure is detected, the UE performs the RRC re-establishment procedure and it also requires the UE to perform RA procedure.

If UE has a full configuration of a cell (that is, a candidate serving cell that is already prepared for potential connection) and knows the exact uplink transmission timing, the candidate serving cell can be used by the UE for communication, when the communication with the serving cell is not available due to various reasons.

For example, when the serving cell is not available due to the beam failure or RLF or other failure reasons, the UE can keep performing the uplink transmission and downlink reception using the candidate serving cell even without performing RA procedure, if the UE performs autonomous cell switching from the serving cell to one of the candidate cells whose UL timing is already known.

Therefore, studies for autonomous serving cell switching in a wireless communication system are required.

Hereinafter, a method for autonomous serving cell switching in a wireless communication system, according to some embodiments of the present disclosure, will be described with reference to the following drawings.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings. Herein, a wireless device may be referred to as a user equipment (UE).

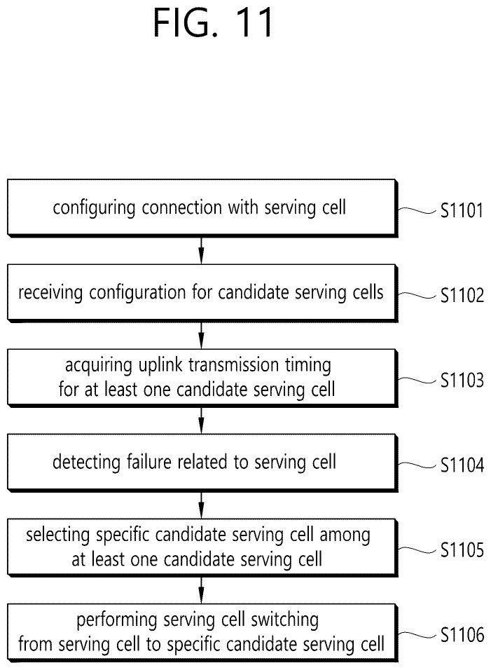

FIG. 11 shows an example of a method for autonomous serving cell switching in a wireless communication system, according to some embodiments of the present disclosure.

In particular, FIG. 11 shows an example of a method performed by a wireless device in a wireless communication system.

In step S1101, a wireless device may configure a connection with a serving cell.

For example, the serving cell is a Primary Cell (PCell), a Primary Secondary Cell Group (SCG) Cell (PSCell), or a Secondary Cell (SCell).

For example, a wireless device may receive a configuration of the serving cell from a network.

In step S1102, a wireless device may receive a configuration for one or more candidate serving cells.

For example, the wireless device may be configured with the one or more candidate serving cells.

For example, the wireless device may receive the preconfiguration of the one or more candidate serving cells.

In step S1103, a wireless device may acquire an uplink transmission timing for at least one candidate serving cell among the one or more candidate serving cells.

For example, the uplink transmission timing for the at least one candidate serving cell may be acquired by performing a Random Access procedure with the at least one candidate serving cell.

For example, the uplink transmission timing for the at least one candidate serving cell may be acquired by calculating the uplink transmission timing based on information received from a network. For example, the information received from the network may includes information on (i) uplink transmission timing difference between the serving cell and the at least one candidate serving cell or (ii) absolute uplink transmission timing of the at least one candidate serving cell.

For example, the uplink transmission timing for the at least one candidate serving cell may be acquired by transmission of UL signals and reception of UL timing update.

In step S1104, a wireless device may detect a failure related to the serving cell.

For example, the wireless device may perform radio link monitoring and/or beam failure detection for the serving cell. The wireless device may detect the failure related to the serving cell by the radio link monitoring and/or the beam failure detection.

For example, the failure related to the serving cell may include a beam failure, a radio link failure, a handover failure, and/or a compliance failure.

For example, the failure related to the serving cell may be detected by a Medium Access Control (MAC) layer of the wireless device. The MAC layer may inform a radio resource control (RRC) layer of the wireless device, information on the specific candidate serving cell, based on that the MAC layer knows the uplink transmission timing for the specific candidate serving cell.

In step S1105, a wireless device may select a specific candidate serving cell among the at least one candidate serving cell for which the uplink transmission timing is acquired.

For example, the specific candidate serving cell is selected based on the uplink transmission timing for the specific candidate serving cell being valid. That is, if there are a first candidate serving cell for which the uplink transmission timing is acquired and a second candidate serving cell for which the uplink transmission timing is not acquired, the wireless device may select the first candidate serving cell.

For example, the wireless device may start a timer upon acquiring the uplink transmission timing for the specific candidate serving cell. The wireless device may consider the uplink transmission timing for the specific candidate serving cell is valid while the timer running.

In step S1106, a wireless device may perform a serving cell switching from the serving cell to the specific candidate serving cell based on the configuration for the specific candidate serving cell.

For example, the wireless device may perform uplink transmission to the specific candidate serving cell without a Random Access procedure. That is, since the wireless device knows the uplink transmission timing, the wireless device could perform uplink transmission to the specific candidate serving cell without performing the Random Access procedure in advance.

According to some embodiments of the present disclosure, a wireless device may receive configuration on a candidate serving cell. The wireless device may detect serving beam/serving cell failure on a serving cell. If the wireless device has a valid uplink transmission timing for a candidate serving cell associated with the serving cell, the wireless device may perform the serving cell switching using the candidate serving cell.

Hereinafter, technical features related to autonomous serving cell switching are described.

For example, new condition for autonomous cell switching could be used in the present disclosure.

A UE is configured with at least one serving cell. The UE is configured with at least one candidate serving cell. The candidate serving cell may be associated with a certain serving cell.

When the beam/serving cell failure is detected for a serving cell, if the UE knows the uplink transmission timing for a candidate serving cell associated with the serving cell, the UE autonomously performs serving cell switching from the serving cell for which the beam/serving cell failure is detected to the candidate serving cell.

When the beam failure is detected on a serving cell, if the UE doesn't know the uplink transmission timing for a candidate serving cell associated with the serving cell, the UE performs Beam Failure Report procedure or Random Access procedure. When the serving cell failure is detected on a serving cell, if the UE doesn't know the uplink transmission timing for a candidate serving cell associated with the serving cell, the UE performs RRC re-establishment procedure.

The candidate serving cell may be associated with a certain serving cell type, i.e. PCell, PSCell, or SCell. When the beam/serving cell failure is detected for a serving cell, if the UE knows the uplink transmission timing for a candidate serving cell associated with the serving cell type of the serving cell, the UE performs serving cell switching from the serving cell for which the beam/serving cell failure is detected to the candidate serving cell.

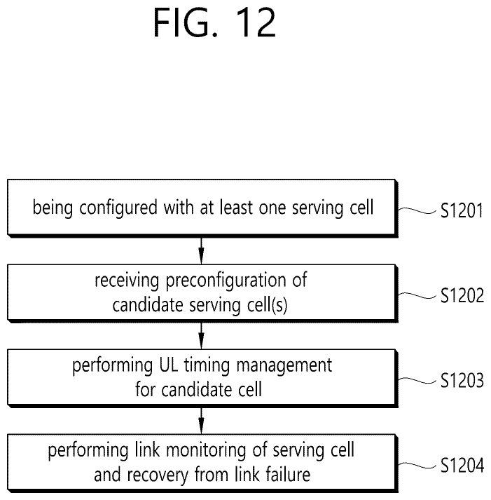

FIG. 12 shows an example of a procedure for autonomous serving cell switching.

In step S1201, UE is configured with at least one serving cell.

For example, UE may receive configuration of the at least one serving cell.

The serving cell is a PCell, a PSCell or a SCell.

In step S1202, UE may receive a preconfiguration of candidate serving cell(s).

The UE is configured with at least one serving cell. The UE is configured with at least one candidate serving cell for mobility.

For example, UE may receive preconfiguration of candidate serving cell(s).

If UE receives a configuration on a candidate serving cell, the UE stores the configuration but doesn't apply it. When the candidate serving cell becomes a serving cell, the UE applies the configuration of the candidate serving cell. The candidate serving cell may become a serving cell if network provides a command for cell switching from the serving cell to the candidate cell.

In step S1203, UE may perform UL timing management for a candidate cell.

The configuration for the candidate serving cell includes resources and parameters for uplink timing control for the candidate serving cell. The UE may perform uplink timing acquisition for the candidate serving cell while the UE is connected to the serving cell.

UE may acquire the uplink transmission timing of the candidate serving cell by performing Random Access procedure with the candidate serving cell. Alternatively, UE may calculate the uplink transmission timing of the candidate serving cell using information received from the network, e.g. uplink transmission timing difference between the serving cell and the candidate serving cell, or absolute uplink transmission timing of the candidate serving cell. Once UE acquires UL timing information via Random Access or transmission of UL signals and reception of UL timing update, the UE may consider the acquired UL timing to be valid until some period of time. The period of time may be governed by a timer, where the timer starts upon initial acquisition of the UL timing or update of the UL timing. The UE considers the UL timing to be valid until the timer running. Upon expiry of the timer, the UE considers that the UL timing to be invalid.

In step S1204, UE may perform link monitoring of a serving cell and recovery from link failure.

The UE performs radio link monitoring and/or beam failure detection of the serving cell. When the beam failure or radio link failure of a serving cell is detected, if the UE knows the uplink transmission timing for a candidate serving cell, the UE performs autonomous cell switching from the serving cell for which the beam/serving cell failure is detected to the candidate serving cell, and if the UE does not know the uplink transmission timing for any candidate cell, the UE does not perform serving cell switching but perform re-establishment if fast MCG recovery is not configured or DC is not configured for the UE.

When the autonomous cell switching is triggered, if the UE knows the uplink transmission timing for a candidate serving cell, the UE switches the serving cell to the candidate serving cell.

The autonomous cell switching is triggered when the beam/serving cell failure is detected.

When the autonomous cell switching is triggered, if the UE knows the uplink transmission timing for more than one candidate serving cell, the UE may select one among the candidate serving cells for which the uplink transmission timing is available, and performs the cell switching using the selected candidate serving cell. For example, two candidate serving cells are configured for an UE, i.e. candidate serving cell A and B. When RLF is detected on PCell. At that time, UE knows the UL timing of cell A but does not know that of cell B. Then, UE changes the PCell from the current PCell to the candidate serving cell A.

If the serving cell switching is triggered for a serving cell, the UE considers the current serving cell as a candidate serving cell and stores the configuration of the serving cell. Alternatively, if the serving cell switching is triggered, the UE discards the configuration of the serving cell. If the serving cell switching is triggered, the UE considers the target candidate serving cell as a serving cell, and applies the configuration of the target candidate serving cell. The terms used in the present disclosure are as follows.

Recovery from beam failure: When the beam failure is detected on a SCell, the UE doesn't perform the serving cell switching and performs the BFR procedure. When the beam failure is detected on a SpCell, if the UE knows the uplink transmission timing for a candidate serving cell, the UE performs SpCell switching from the SpCell for which the beam failure is detected to the candidate serving cell.

Recovery from RLF: UE may consider the serving cell failure is detected, if the Radio Link Failure is detected for the serving cell.

Recovery from handover failure: UE may consider the serving cell failure is detected, if the SpCell change, i.e. mobility with sync, is failed.

Recovery from compliance failure: UE may consider the serving cell failure is detected, if the UE is unable to comply with (part of) the configuration included in the RRCReconfiguration message.

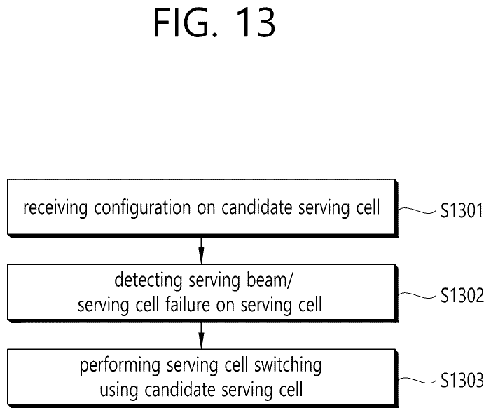

FIG. 13 shows an example of a method for autonomous serving cell switching performed by a UE.

In step 1301, UE receives the configuration on a candidate serving cell.

The configuration includes all information for the candidate serving cell to work as a serving cell. Upon receiving the configuration, the UE stores the configuration but doesn't apply it (that is, the UE doesn't consider the candidate serving cell as a serving cell).

After receiving the configuration, the UE may perform RA procedure to acquire the uplink transmission timing of the candidate serving cell. Otherwise, the assistance information to acquire the uplink transmission timing of the candidate serving cell, e.g. uplink transmission timing difference between the serving cell and the candidate serving cell, may be included in the configuration.

In step 1302, UE detects serving beam/serving cell failure on a serving cell.

In step 1303, if UE has a valid uplink transmission timing for a candidate serving cell associated with the serving cell, the UE may perform the serving cell switching using the candidate serving cell.

When the beam failure is detected and the MAC layer knows the uplink transmission timing of a candidate serving cell, the MAC layer informs RRC layer of the candidate serving cell identity. Then the RRC layer initiates the serving cell switching using the candidate serving cell indicated by the MAC layer.

If UE knows the uplink transmission timing for more than one candidate serving cell, the UE may choose one based on the quality of the candidate serving cells, e.g. DL measurement results.

Hereinafter, technical features related to autonomous serving cell switching, to which implementations of the present disclosure is applied, are described. In particular, operations related to LTM configuration and execution are described.

The network configures the UE with one or more LTM candidate configurations within the LTM-Config IE.

In NR-DC, the UE may receive two independent ltm-Config:
an ltm-Config associated with the MCG that is included within an RRCReconfiguration message received via SRB1; and
an ltm-Config associated with the SCG that is included within an RRCReconfiguration message either received via SRB3, or, alternatively, embedded in an RRCReconfiguration message received via SRB1.

In this case:
the UE maintains two independent VarLTM-Config, one associated with each ltm-Config;
the UE maintains two independent VarLTM-ServingCellNoResetID, one associated with each ltm-Config;
the UE maintains two independent VarLTM-ServingCellUE-MeasuredTA-ID, one associated with each ltm-Config;
the UE independently performs all the procedures for each ltm-Config and the associated VarLTM-Config, unless explicitly stated otherwise.

The UE shall perform the following actions based on the received LTM-Config IE:
1> if the received LTM-Config includes ltm-ReferenceConfiguration:
2> if the current VarLTM-Config includes an ltm-ReferenceConfiguration:
3> replace the ltm-ReferenceConfiguration value within VarLTM-Config with the received ltm-ReferenceConfiguration;
2> else:
3> store the received ltm-ReferenceConfiguration to VarLTM-Config;
1> if the received LTM-Config includes ltm-ServingCellNoResetID:
2> if the current VarLTM-ServingCellNoResetID includes an ltm-ServingCellNoResetID:
3> replace the ltm-ServingCellNoResetID value within VarLTM-ServingCellNoResetID with the received ltm-ServingCellNoResetID;
2> else:
3> store the received ltm-ServingCellNoResetID to VarLTM-ServingCellNoResetID;
1> if the received LTM-Config includes ltm-ServingCellUE-MeasuredTA-ID:
2> if the current VarLTM-ServingCellUE-MeasuredTA-ID includes an ltm-ServingCellUE-MeasuredTA-ID:
3> replace the ltm-ServingCellUE-MeasuredTA-ID value within VarLTM-ServingCellUE-MeasuredTA-ID with the received ltm-ServingCellUE-MeasuredTA-ID;
2> else:
3> store the received ltm-ServingCellUE-MeasuredTA-ID to VarLTM-ServingCellUE-MeasuredTA-ID;
1> if the received LTM-Config includes ltm-CSI-ResourceConfigToAddModList:
2> if the current VarLTM-Config includes an ltm-CSI-ResourceConfigToAddModList:
3> replace the ltm-CSI-ResourceConfigToAddModList value within VarLTM-Config with the received ltm-CSI-ResourceConfigToAddModList;
2> else:
3> store the received ltm-CSI-ResourceConfigToAddModList to VarLTM-Config;
1> if the LTM-Config includes the ltm-CandidateToReleaseList:
2> perform the LTM candidate configuration release;
1> else if the received LTM-Config includes the ltm-CandidateToAddModList:
2> perform the LTM candidate cell addition or reconfiguration;

Operations related to LTM candidate configuration release are described.

The UE shall:
1> for each ltm-CandidateId value included in the ltm-CandidateToReleaseList that is part of the current UE LTM candidate configuration in VarLTM-Config:
2> if the current VarLTM-Config includes an LTM-Candidate associated with the given ltm-CandidateId value:
3> remove the entry related to LTM-Candidate from VarLTM-Config;

Operations related to LTM candidate cell addition/modification are described.

The UE shall:
1> for each ltm-CandidateId value in the ltm-CandidateToAddModList:
2> if the current VarLTM-Config includes an LTM-Candidate with the given ltm-CandidateId value:
3> replace the LTM-Candidate within VarLTM-Config in accordance with the received LTM-Candidate;
2> else:
3> add the received LTM-Candidate to VarLTM-Config.

Operations related to LTM cell switch execution are described.

Upon the indication by lower layers that an LTM cell switch procedure is triggered, or upon performing LTM cell switch following cell selection performed while timer T311 was running, the UE shall:
1> release/clear all current dedicated radio configuration associated with the cell group for which the LTM cell switch procedure is triggered except for the following:
2> if the LTM cell switch is triggered on the MCG:
   the MCG C-RNTI;
   the AS security configurations associated with the master key;
2> else, if the LTM cell switch is triggered on the SCG:
   the AS security configurations associated with the secondary key;
2> for each SRB/DRB in current UE configuration:
   keep the associated PDCP and SDAP entities, their state variables, buffers and timers;
   release all fields related to the SRB/DRB configuration except for srb-Identity and drb-Identity;
2> for each RLC bearer in current UE configuration of the cell group for which LTM is triggered:
   keep the associated RLC entity, its state variables, buffers, and timers;
   release all fields related to the RLC-BearerConfig except for logicalChannelIdentity and logicalChannelIdentityExt.
   the UE variables VarLTM-Config and VarLTM-ServingCellNoResetID.

Upon an LTM cell switch, the UE shall release the radio bearer(s) and the associated logical channel(s) that are part of the current UE's configuration but not part of the LTM candidate configuration indicated by lower layers or the LTM reference configuration.
1> release/clear all current common radio configuration associated with the cell group for which the LTM cell switch procedure is triggered;
1> use the default values for timers T310, T311 and constants N310, N311 associate to cell group for which the LTM cell switch procedure is triggered;
1> apply the default L1 parameter values as specified in corresponding physical layer specifications;
1> if the value of field ltm-NoResetID contained within the LTM-Candidate IE in VarLTM-Config indicated by lower layers or for the selected cell is equal to the value of ltm-ServingCellNoResetID within VarLTM-ServingCellNoResetID:
2> continue using the current RLC entity in the LTM candidate configuration indicated by lower layers;
2> replace the value of ltm-ServingCellNoResetID in VarLTM-ServingCellNoResetID with the value received within ltm-NoResetID;
1> else:
2> for each RLC-BearerConfig within rlc-Bearer ToAddModList that is part of current UE configuration:
3> re-establish the RLC entity;
2> for each drb-Identity value included in the drb-ToAddModList that is part of the current UE configuration:
3> trigger the PDCP entity of this DRB to perform data recovery;
2> replace the value of ltm-ServingCellNoResetID in VarLTM-ServingCellNoResetID with the value of ltm-NoResetID in the LTM-Candidate in VarLTM-Config indicated by lower layers or for the selected cell;
1> if the value of field ltm-UE-MeasuredTA-ID contained within the LTM-Candidate IE in VarLTM-Config indicated by lower layers or for the selected cell is equal to the value of ltm-ServingCellUE-MeasuredTA-ID within VarLTM-ServingCellUE-MeasuredTA-ID:
2> inform lower layers that UE should perform UE-based TA measurements;
2> replace the value of ltm-ServingCellUE-MeasuredTA-ID in VarLTM-ServingCellUE-MeasuredTA-ID with the value received within ltm-UE-MeasuredTA-ID;
1> else:
2> replace the value of ltm-ServingCellUE-MeasuredTA-ID in VarLTM-ServingCellUE-MeasuredTA-ID with the value of ltm-UE-MeasuredTA-ID in the LTM-Candidate in VarLTM-Config indicated by lower layers or for the selected cell;
1> continue using the current PDCP entity in the LTM candidate configuration indicated by lower layers; 1> if ltm-ConfigComplete is not included within the LTM-Candidate IE in VarLTM-Config indicated by lower layers or for the selected cell:
2> consider ltm-ReferenceConfiguration in VarLTM-Config to be the current UE configuration.

When the UE considers the reference configuration to be the current UE configuration, the UE should store fields and configurations that are part of the reference configuration but should not execute any actions or procedures triggered by the reception of an RRCReconfiguration message.
1> if the LTM cell switch is triggered by an indication from lower layers:
2> apply the LTM configuration in ltm-CandidateConfig within LTM-Candidate IE in VarLTM-Config related to the LTM candidate configuration identity as received from lower layers;
1> else (LTM cell switch triggered upon cell selection performed while timer T311 was running):
2> apply the LTM configuration in ltm-CandidateConfig within LTM-Candidate IE in VarLTM-Config related to the LTM candidate configuration identity corresponding to the cell selected while timer T311 was running;
2> perform LTM configuration release procedure for the MCG.

It is up to the UE implementation to apply the LTM candidate configuration on top of the LTM reference configuration before lower layers trigger the execution of an LTM cell switch.

Operations related to LTM configuration release are described.

For the cell group for which the LTM configuration release procedure is triggered, the UE shall:
1> remove all entries within VarLTM-Config;
1> remove all entries within VarLTM-ServingCellNoResetID;
1> remove all entries within VarLTM-ServingCellUE-MeasuredTA-ID;
1> release ltm-Config;
1> release from current UE configuration all entries of ltm-CSI-ReportConfigToAddModList for all serving cell.

Some of the detailed steps shown in the examples of FIGS. 11, 12, and 13 may not be essential steps and may be omitted. In addition to the steps shown in FIGS. 11, 12, and 13 other steps may be added, and the order of the steps may vary. Some of the above steps may have their own technical meaning.

Hereinafter, an apparatus for autonomous serving cell switching in a wireless communication system, according to some embodiments of the present disclosure, will be described. Herein, the apparatus may be a wireless device (100 or 200) in FIGS. 2, 3, and 5.

For example, a wireless device may perform methods described above. The detailed description overlapping with the above-described contents could be simplified or omitted.

Referring to FIG. 5, a wireless device 100 may include a processor 102, a memory 104, and a transceiver 106.

According to some embodiments of the present disclosure, the processor 102 may be configured to be coupled operably with the memory 104 and the transceiver 106.

The processor 102 may be adapted to configure a connection with a serving cell. The processor 102 may be adapted to receive a configuration for one or more candidate serving cells. The processor 102 may be adapted to acquire an uplink transmission timing for at least one candidate serving cell among the one or more candidate serving cells. The processor 102 may be adapted to detect a failure related to the serving cell. The processor 102 may be adapted to select a specific candidate serving cell among the at least one candidate serving cell for which the uplink transmission timing is acquired. The processor 102 may be adapted to perform a serving cell switching from the serving cell to the specific candidate serving cell based on the configuration for the specific candidate serving cell.

For example, the specific candidate serving cell may be selected based on the uplink transmission timing for the specific candidate serving cell being valid.

For example, the processor 102 may be adapted to start a timer upon acquiring the uplink transmission timing for the specific candidate serving cell.

For example, the processor 102 may be adapted to consider the uplink transmission timing for the specific candidate serving cell is valid while the timer running.

For example, the processor 102 may be adapted to perform radio link monitoring and/or beam failure detection for the serving cell.

For example, the processor 102 may be adapted to perform uplink transmission to the specific candidate serving cell without a Random Access procedure.

For example, the serving cell may be a Primary Cell (PCell), a Primary Secondary Cell Group (SCG) Cell (PSCell), or a Secondary Cell (SCell).

For example, the processor 102 may be adapted to receive a configuration of the serving cell.

For example, the failure related to the serving cell may include a beam failure, a radio link failure, a handover failure, and/or a compliance failure.

For example, the failure related to the serving cell may be detected by a Medium Access Control (MAC) layer of the wireless device.

For example, the processor 102 may be adapted to inform, by the MAC layer, a radio resource control (RRC) layer of the wireless device of information on the specific candidate serving cell, based on that the MAC layer knows the uplink transmission timing for the specific candidate serving cell.

For example, the uplink transmission timing for the at least one candidate serving cell may be acquired by performing a Random Access procedure with the at least one candidate serving cell.

For example, the uplink transmission timing for the at least one candidate serving cell may be acquired by calculating the uplink transmission timing based on information received from a network.

For example, the processor 102 may be adapted to control the transceiver 106 to be in communication with at least one of a user equipment, a network, or an autonomous vehicle other than the wireless device.

Hereinafter, a processor for a wireless device for autonomous serving cell switching in a wireless communication system, according to some embodiments of the present disclosure, will be described.

The processor may be adapted to control the wireless device to configure a connection with a serving cell. The processor may be adapted to control the wireless device to receive a configuration for one or more candidate serving cells. The processor may be adapted to control the wireless device to acquire an uplink transmission timing for at least one candidate serving cell among the one or more candidate serving cells. The processor may be adapted to control the wireless device to detect a failure related to the serving cell. The processor may be adapted to control the wireless device to select a specific candidate serving cell among the at least one candidate serving cell for which the uplink transmission timing is acquired. The processor may be adapted to control the wireless device to perform a serving cell switching from the serving cell to the specific candidate serving cell based on the configuration for the specific candidate serving cell.

For example, the specific candidate serving cell may be selected based on the uplink transmission timing for the specific candidate serving cell being valid.

For example, the processor may be adapted to control the wireless device to start a timer upon acquiring the uplink transmission timing for the specific candidate serving cell.

For example, the processor may be adapted to control the wireless device to consider the uplink transmission timing for the specific candidate serving cell is valid while the timer running.

For example, the processor may be adapted to control the wireless device to perform radio link monitoring and/or beam failure detection for the serving cell.

For example, the processor may be adapted to control the wireless device to perform uplink transmission to the specific candidate serving cell without a Random Access procedure.

For example, the serving cell may be a Primary Cell (PCell), a Primary Secondary Cell Group (SCG) Cell (PSCell), or a Secondary Cell (SCell).

For example, the processor may be adapted to control the wireless device to receive a configuration of the serving cell.

For example, the failure related to the serving cell may include a beam failure, a radio link failure, a handover failure, and/or a compliance failure.

For example, the failure related to the serving cell may be detected by a Medium Access Control (MAC) layer of the wireless device.

For example, the processor may be adapted to control the wireless device to inform, by the MAC layer, a radio resource control (RRC) layer of the wireless device of information on the specific candidate serving cell, based on that the MAC layer knows the uplink transmission timing for the specific candidate serving cell.

For example, the uplink transmission timing for the at least one candidate serving cell may be acquired by performing a Random Access procedure with the at least one candidate serving cell.

For example, the uplink transmission timing for the at least one candidate serving cell may be acquired by calculating the uplink transmission timing based on information received from a network.

For example, the processor may be configured to control the wireless device to be in communication with at least one of a user equipment, a network, or an autonomous vehicle other than the wireless device.

Hereinafter, a non-transitory computer-readable medium has stored thereon a plurality of instructions for autonomous serving cell switching in a wireless communication system, according to some embodiments of the present disclosure, will be described.

According to some embodiment of the present disclosure, the technical features of the present disclosure could be embodied directly in hardware, in a software executed by a processor, or in a combination of the two. For example, a method performed by a wireless device in a wireless communication may be implemented in hardware, software, firmware, or any combination thereof. For example, a software may reside in RAM memory, flash memory, ROM memory, EPROM memory, EEPROM memory, registers, hard disk, a removable disk, a CD-ROM, or any other storage medium.

Some example of storage medium is coupled to the processor such that the processor can read information from the storage medium. In the alternative, the storage medium may be integral to the processor. The processor and the storage medium may reside in an ASIC. For another example, the processor and the storage medium may reside as discrete components.

The computer-readable medium may include a tangible and non-transitory computer-readable storage medium.

For example, non-transitory computer-readable media may include random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, or any other medium that can be used to store instructions or data structures. Non-transitory computer-readable media may also include combinations of the above.

In addition, the method described herein may be realized at least in part by a computer-readable communication medium that carries or communicates code in the form of instructions or data structures and that can be accessed, read, and/or executed by a computer.

According to some embodiment of the present disclosure, a non-transitory computer-readable medium has stored thereon a plurality of instructions. The stored a plurality of instructions may be executed by a processor of a wireless device.

The stored a plurality of instructions may cause the wireless device to configure a connection with a serving cell. The stored a plurality of instructions may cause the wireless device to receive a configuration for one or more candidate serving cells. The stored a plurality of instructions may cause the wireless device to acquire an uplink transmission timing for at least one candidate serving cell among the one or more candidate serving cells. The stored a plurality of instructions may cause the wireless device to detect a failure related to the serving cell. The stored a plurality of instructions may cause the wireless device to select a specific candidate serving cell among the at least one candidate serving cell for which the uplink transmission timing is acquired. The stored a plurality of instructions may cause the wireless device to perform a serving cell switching from the serving cell to the specific candidate serving cell based on the configuration for the specific candidate serving cell.

For example, the specific candidate serving cell may be selected based on the uplink transmission timing for the specific candidate serving cell being valid.

For example, the stored a plurality of instructions may cause the wireless device to start a timer upon acquiring the uplink transmission timing for the specific candidate serving cell.

For example, the stored a plurality of instructions may cause the wireless device to consider the uplink transmission timing for the specific candidate serving cell is valid while the timer running.

For example, the stored a plurality of instructions may cause the wireless device to perform radio link monitoring and/or beam failure detection for the serving cell.

For example, the stored a plurality of instructions may cause the wireless device to perform uplink transmission to the specific candidate serving cell without a Random Access procedure.

For example, the serving cell may be a Primary Cell (PCell), a Primary Secondary Cell Group (SCG) Cell (PSCell), or a Secondary Cell (SCell).

For example, the stored a plurality of instructions may cause the wireless device to receive a configuration of the serving cell.

For example, the failure related to the serving cell may include a beam failure, a radio link failure, a handover failure, and/or a compliance failure.

For example, the failure related to the serving cell may be detected by a Medium Access Control (MAC) layer of the wireless device.

For example, the stored a plurality of instructions may cause the wireless device to inform, by the MAC layer, a radio resource control (RRC) layer of the wireless device of information on the specific candidate serving cell, based on that the MAC layer knows the uplink transmission timing for the specific candidate serving cell.

For example, the uplink transmission timing for the at least one candidate serving cell may be acquired by performing a Random Access procedure with the at least one candidate serving cell.

For example, the uplink transmission timing for the at least one candidate serving cell may be acquired by calculating the uplink transmission timing based on information received from a network.

For example, the stored a plurality of instructions may cause the wireless device to be in communication with at least one of a user equipment, a network, or an autonomous vehicle other than the wireless device.

Hereinafter, a method performed by a base station (BS) for autonomous serving cell switching in a wireless communication system, according to some embodiments of the present disclosure, will be described.

The BS may transmit, to a wireless device, a configuration of a serving cell. The BS may transmit, to the wireless device, a preconfiguration for one or more candidate serving cells. The BS may transmit, to the wireless device, information on uplink transmission timing for at least one candidate serving cell among the one or more candidate serving cells. The BS may receive, to the wireless device, uplink data via the serving cell. The BS may receive, to the wireless device, uplink data via a specific candidate cell among one or more candidate serving cells without a Random Access procedure.

Hereinafter, a base station (BS) for autonomous serving cell switching in a wireless communication system, according to some embodiments of the present disclosure, will be described.

The BS may include a transceiver, a memory, and a processor operatively coupled to the transceiver and the memory.

The processor may be adapted to transmit, to a wireless device, a configuration of a serving cell. The processor may be adapted to transmit, to the wireless device, a preconfiguration for one or more candidate serving cells. The processor may be adapted to transmit, to the wireless device, information on uplink transmission timing for at least one candidate serving cell among the one or more candidate serving cells. The processor may be adapted to receive, to the wireless device, uplink data via the serving cell. The processor may be adapted to receive, to the wireless device, uplink data via a specific candidate cell among one or more candidate serving cells without a Random Access procedure.

The present disclosure can have various advantageous effects.

According to some embodiments of the present disclosure, a wireless device could efficiently perform the autonomous serving cell switching.

When the serving cell is not available due to the beam failure or RLF, the UE can keep performing the uplink transmission and downlink reception using the candidate serving cell even without performing RA procedure.

In other words, by acquiring the uplink transmission timing in advance, the wireless device could perform the autonomous serving cell switching efficiently.

According to some embodiments of the present disclosure, a wireless communication system could provide an efficient solution for the autonomous serving cell switching.

For example, the network could efficiently provide the configuration and/or the uplink transmission timing of the candidate serving cells for the autonomous serving cell switching.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1-32. (canceled)

33. A method, comprising:
configuring, by a wireless device, a connection with a serving cell;
receiving, by the wireless device, a configuration for one or more candidate serving cells;
acquiring, by the wireless device, an uplink transmission timing for at least one candidate serving cell among the one or more candidate serving cells;
detecting, by the wireless device, a failure related to the serving cell;
selecting, by the wireless device, a specific candidate serving cell among the at least one candidate serving cell for which the uplink transmission timing is acquired; and
performing, by the wireless device, a serving cell switching from the serving cell to the specific candidate serving cell based on the configuration for the specific candidate serving cell.

34. The method of claim 33,
wherein the specific candidate serving cell is selected based on the uplink transmission timing for the specific candidate serving cell being valid.

35. The method of claim 33, wherein the method further comprising,
starting, by the wireless device, a timer upon acquiring the uplink transmission timing for the specific candidate serving cell.

36. The method of claim 35, wherein the method further comprising,
considering, by the wireless device, the uplink transmission timing for the specific candidate serving cell is valid while the timer running.

37. The method of claim 33, wherein the method further comprising,
performing, by the wireless device, radio link monitoring and/or beam failure detection for the serving cell.

38. The method of claim 33, wherein the method further comprising,
performing, by the wireless device, uplink transmission to the specific candidate serving cell without a Random Access procedure.

39. The method of claim 33,
wherein the serving cell is a Primary Cell (PCell), a Primary Secondary Cell Group (SCG) Cell (PSCell), or a Secondary Cell (SCell).

40. The method of claim 33, wherein the method further comprises,
receiving, by the wireless device, a configuration of the serving cell.

41. The method of claim 33,
wherein the failure related to the serving cell includes a beam failure, a radio link failure, a handover failure, and/or a compliance failure.

42. The method of claim 33,
wherein the failure related to the serving cell is detected by a Medium Access Control (MAC) layer of the wireless device.

43. The method of claim 42, wherein the method further comprises,
informing, by the MAC layer of the wireless device, a radio resource control (RRC) layer of the wireless device of information on the specific candidate serving cell, based on that the MAC layer knows the uplink transmission timing for the specific candidate serving cell.

44. The method of claim 33,
wherein the uplink transmission timing for the at least one candidate serving cell is acquired by performing a Random Access procedure with the at least one candidate serving cell.

45. The method of claim 33,
wherein the uplink transmission timing for the at least one candidate serving cell is acquired by calculating the uplink transmission timing based on information received from a network.

46. The method of claim 33,
wherein the wireless device is in communication with at least one of a user equipment, a network, or an autonomous vehicle other than the wireless device.

47. A wireless device, comprising:
a transceiver;
a memory; and
at least one processor operatively coupled to the transceiver and the memory, and adapted to:
configure a connection with a serving cell;
receive a configuration for one or more candidate serving cells;
acquire an uplink transmission timing for at least one candidate serving cell among the one or more candidate serving cells;
detect a failure related to the serving cell;
select a specific candidate serving cell among the at least one candidate serving cell for which the uplink transmission timing is acquired; and
perform a serving cell switching from the serving cell to the specific candidate serving cell based on the configuration for the specific candidate serving cell.

48. The wireless device of claim 47,
wherein the specific candidate serving cell is selected based on the uplink transmission timing for the specific candidate serving cell being valid.

49. The wireless device of claim 47, wherein the at least one processor is further adapted to,
start a timer upon acquiring the uplink transmission timing for the specific candidate serving cell.

50. The wireless device of claim 49, wherein the at least one processor is further adapted to,
consider the uplink transmission timing for the specific candidate serving cell is valid while the timer running.

51. The wireless device of claim 47, wherein the at least one processor is further adapted to,
perform radio link monitoring and/or beam failure detection for the serving cell.

52. A base station, comprising:
a transceiver;
a memory; and
a processor operatively coupled to the transceiver and the memory, and adapted to:
transmit, to a wireless device, a configuration of a serving cell;
transmit, to the wireless device, a preconfiguration for one or more candidate serving cells;
transmit, to the wireless device, information on uplink transmission timing for at least one candidate serving cell among the one or more candidate serving cells;
receive, to the wireless device, uplink data via the serving cell; and
receive, to the wireless device, uplink data via a specific candidate cell among one or more candidate serving cells without a Random Access procedure.
